(19) United States
(12) Patent Application Publication
(10) Pub. No.: US 2007/0053547 A1
(43) Pub. Date: Mar. 8, 2007

(54) Diaphragm for use in speakers and speaker provided with this diaphragm

(75) Inventor: Seiichi Ando, Tokyo (JP)

Correspondence Address: DENNIS G. LAPOINTE;LAPOINTE LAW GROUP, PL, PO BOX 1294, TARPON SPRINGS, FL, 34688-1294, US

(73) Assignee: FOSTER ELECTRIC CO., LTD., Tokyo (JP)

(21) Appl. No.: 11/517,044

(22) Filed: Sep. 7, 2006

(30) Foreign Application Priority Data
Sep. 15, 2005 (JP) 2005-267815
Sep. 8, 2005 (JP) DES. 2005-25933

(51) Int. Cl. H04R 9/06

(52) U.S. Cl. 381/430

(57) ABSTRACT

A diaphragm for use in speakers in which a center dome is provided with a plurality of ribs in one of axial symmetry and non-axial symmetry patterns, for thereby dispersing the divisional resonance occurring in the center dome during the vibration and lowering the sound pressure specifically in higher sound range frequency characteristics, as well as a speaker comprising the particular diaphragm, are provided.

### BACKGROUND OF THE INVENTION

1. Field of the Invention

This invention relates to a diaphragm for use in speakers specifically of small and thin type employed in personal computers, mobile phones, car-loaded ETC equipments and the like, and to a speaker provided with such diaphragm.

2. Description of Related Art

For conventional diaphragms for use in speakers of the kind referred to, there has been a diaphragm 1a′, generally as shown in FIG. 9A, having in the center a circular diaphragm part 2′ which functions also as a dust preventing cover, and in outer periphery thereof an annular diaphragm part 4′ formed integral through a voice-coil joining part 3′.

For the shape of this central circular diaphragm part 2′ of the diaphragm 1a′, a dome shape axially symmetric has been mainly adopted, and this part shall be referred to as a center dome 2′ in the following description. Further, the outer peripheral annular diaphragm part 4′ is also a swelling ring shape of rotation symmetry with an arc rotated about an axis of the center dome 2′.

In a speaker comprising this diaphragm 1a′, as shown in FIG. 9B, a cylindrical bobbin 10′ carrying a voice coil on the periphery at one end portion is joined to the rear side surface of the voice-coil joining part 3′ between the center dome 2′ and the annular diaphragm part 4′, so as to retain the voice coil for vibration within a magnetic gap of a magnetic circuit 11′. Also, an edge part constituted by the outer peripheral part of the annular diaphragm part 4′ is secured to an outer peripheral edge of a frame part expanding around the magnetic gap of a yoke which constitutes the magnetic circuit 11′. As electric signals corresponding to the voice or sound to be reproduced are input to the voice coil, the bobbin 10′ vibrates in axial directions, and this vibration drives through the voice-coil joining part 3′ the diaphragm 1a′.

Since, in the speaker of the foregoing arrangement, the voice-coil joining part 3′ through which the diaphragm 1a′ receives the driving of the bobbin 10′ comprises, as seen in the sectioned view of FIG. 9B, a shallow valley portion between the center dome 2′ and the annular diaphragm part 4′, both gradually swelling, so as to keep the speaker to be of the thin type, the part 3′ is lower in the mechanical strength than in the case where it comprises a deep valley and is relatively easily bendable. As a result, the vibration of the bobbin cannot be transmitted uniformly to the whole of the diaphragm, causing abnormal resonance and divisional resonance to occur, and the particular diaphragm or speaker involves a defect that desired frequency characteristics cannot be obtained.

In order to remove the foregoing defect, Japanese Laid-Open Utility Model Publication Nos. S61-37689, S41-15283 and S56-74595 disclose such speakers as collectively shown in a plan view of FIG. 10. In FIG. 10, a diaphragm 1b′ is formed to have ribs 12′ which are reverse V- or U-shaped in section and extending radially from the center dome 2′, so as to bridge across the valley portion between the center dome 2′ and the annular diaphragm part 4′, at a plurality of positions radially equally spaced apart along the voice coil joining part 3′ formed by the circular valley portion on outer front side, with an intention of improving the mechanical strength of the voice-coil joining part 3′.

While such diaphragms 1b′ having the ribs 12′ as in the above can transmit the vibration of the voice coil bobbin 10′ certainly to the center dome 2′ and annular diaphragm part because of the improvement in the strength of the voice coil joining part 3′, the shape of the center dome 2′ is retained in the dome shape of the axial symmetry, so that the vibration transmitted certainly will be rather effective to promote simultaneous occurrence of the divisional resonance at many portions within the dome, which resonance will be concentrated to become a large resonance, and there remains a problem that in particular a sound pressure level in middle and high sound zones is caused to rise and only an ill balanced frequency characteristics can be obtained.

FIG. 11 shows respective frequency characteristic curves of the speaker employing the diaphragm 1a′ of FIG. 9 having no ribs with a broken line curve C, and of the speaker employing the diaphragm 1b′ of FIG. 10 having the ribs 12′ with a solid line curve D. As will be clear from these characteristic curves, it is remarkable that the sound pressure level rises at lower sound range in the case where the diaphragm 1b′ having the ribs is employed, whereas the sound pressure level in higher sound range in particular is remarkably caused to rise in both of the curves C and D. Thus, it is found that the foregoing problem still remains unsolved even when the ribs are provided at the voice-coil joining part, since a main effect of the provision of the ribs 12′ to the diaphragm 1b′ is shown only in a contribution to the increment in the mechanical strength with the strengthening of the voice coil joining part, but not in any positive contribution to the dispersion of the divisional resonance occurring in the center dome 2′.

### SUMMARY OF THE INVENTION

This invention has been suggested in view of the foregoing problem, and its object is to provide a diaphragm for use in speakers and a speaker using this diaphragm which can control the rise of the frequency in the higher sound range so as to be able to obtain a sound reproduction of excellent tone quality, by dispersing the divisional resonance occurring in the center dome in the diaphragm comprising the center dome and annular diaphragm part surrounding the dome.

The foregoing object of the present invention can be attained by means of a diaphragm for use in speakers characterized in that, in the diaphragm which comprises a center dome of a circular dome shape and an annular diaphragm part formed continuously around the center dome through a voice-coil joining part, the center dome is provided with a plurality of ribs formed to have one of V-shape and U-shape in section and disposed to continue to outer peripheral edge of the dome at least at one of longitudinal ends of the ribs and to be in one of axial symmetry and non-axial symmetry.

The above object can be also attained by means of a diaphragm for use in speakers characterized in that the plurality of ribs in the center dome are disposed mutually in one of equally spaced and unequally spaced patterns and substantially in parallel relationship.

The above object can be also attained by means of a diaphragm for use in speakers characterized in that the plurality of ribs disposed in equally and unequally spaced and mutually parallel pattern are in contact respectively at both ends with outer peripheral edge of the center dome.

The above object can be also attained by means of a diaphragm for use in speakers characterized in that the plurality of ribs in the center dome are a pair which are mutually spaced in non-parallel relationship.

The above object can be also attained by means of a diaphragm for use in speakers characterized in that the pair of ribs mutually not in parallel in the center dome are in contact respectively at both ends with the outer peripheral edge of the center dome.

The above object can also be attained by means of a diaphragm for use in speakers characterized in that the plurality of ribs are disposed to form a square shape while surrounding the center of the center dome.

The above object can also be attained by means of a diaphragm for use in speakers characterized in that the plurality of ribs disposed in the square shape are disposed respectively in contact at one end with the outer peripheral edge of the center dome and at the other end with adjacent another rib.

The foregoing object of the present invention is also attainable by means of a speaker comprising a magnetic circuit consisting of a disk-shaped magnet, a disk-shaped pole piece positioned on one surface of the magnet, and a yoke including an opposing part with respect to a circular outer peripheral edge of the pole piece while covering the other surface and side surface of the magnet for forming a magnetic gap at the opposing part and a frame part expanding from the opposing part substantially in the same plane as the pole piece and having a circular outer peripheral end, and a diaphragm consisting of a center dome of a circular dome shape and opposing the pole piece of the magnetic circuit,

an annular diaphragm part formed as continuously joined at inner peripheral edge and through a voice-coil joining part with outer peripheral edge of the center dome, the diaphragm part being fixed at outer peripheral edge to outer peripheral end of the frame part of the yoke, and a bobbin joined at one axial end to the voice-coil joining part and carrying on outer periphery at the other axial end a voice coil retained within the magnetic gap, characterized in that the center dome of the diaphragm is provided with a plurality of ribs formed to be of one of V-shape and U-shape in section and to be in contact at least at one longitudinal end with the outer peripheral edge of the center dome, the ribs being disposed in one of axial symmetry and non-axial symmetry.

### BRIEF DESCRIPTION OF THE DRAWINGS

FIG. 1A is a plan view of the diaphragm for use in speakers in a first embodiment according to the present invention;

FIG. 1B is a perspective view of the diaphragm in FIG. 1A;

FIG. 2 is a central cross sectioned view showing generally a speaker employing the diaphragm of FIG. 1;

FIG. 3 is a frequency characteristic diagram showing the characteristics of the speaker utilizing the diaphragm provided with the ribs according to the present invention in comparison with a conventional speaker having no ribs;

FIG. 4 is a plan view of a center dome in the diaphragm for use in speakers in a second embodiment according to the present invention;

FIG. 5 is a plan view of a center dome in the diaphragm for use in speakers in a third embodiment according to the present invention;

FIG. 6 is a plan view of a center dome in the diaphragm for use in speakers in a fourth embodiment according to the present invention;

FIG. 7 is a plan view of a center dome in the diaphragm for use in speakers in a fifth embodiment according to the present invention;

FIG. 8A is a general view showing an example of sectional shape of the ribs employed in the diaphragm according to the present invention;

FIG. 8B is a general view showing another example of sectional shape of the ribs employed in the diaphragm according to the present invention;

FIG. 9A is a plan view of a conventional diaphragm for use in speakers;

FIG. 9B is a general cross sectional view of the speaker using the conventional diaphragm in FIG. 9A;

FIG. 10 is a plan view of a conventional diaphragm for use in speakers, the diaphragm being provided with radial ribs as equally spaced on upper side of the voice-coil joining part between the center dome and the annular diaphragm part, the rib being substantially in a reverse V-shape in section; and

FIG. 11 is a frequency characteristic diagram showing the characteristics in the case of the diaphragm having no rib as in FIG. 9A in comparison with the characteristics in the case of the diaphragm having the conventional ribs as in FIG. 10.

### DETAILED DESCRIPTION OF THE PREFERRED EMBODIMENTS

Preferred embodiments according to the present invention shall now be described in the followings with reference to the drawings.

### Embodiment 1

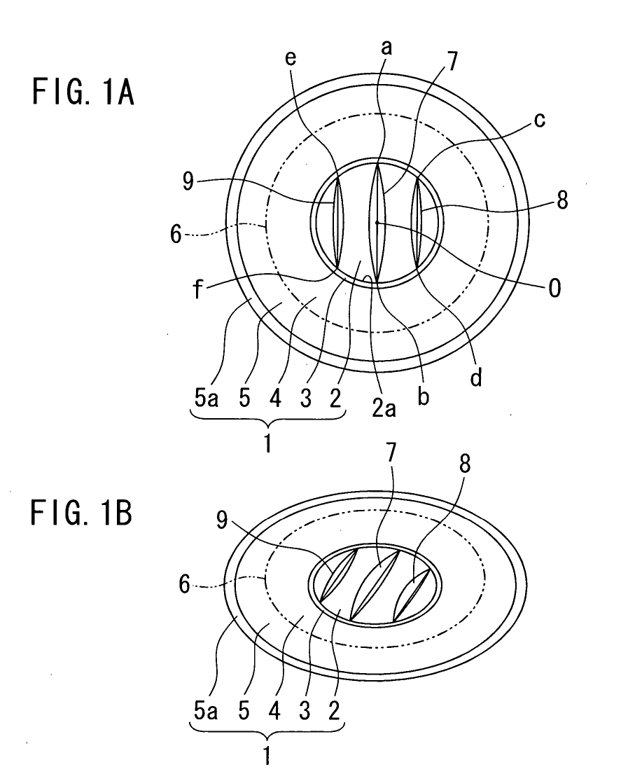

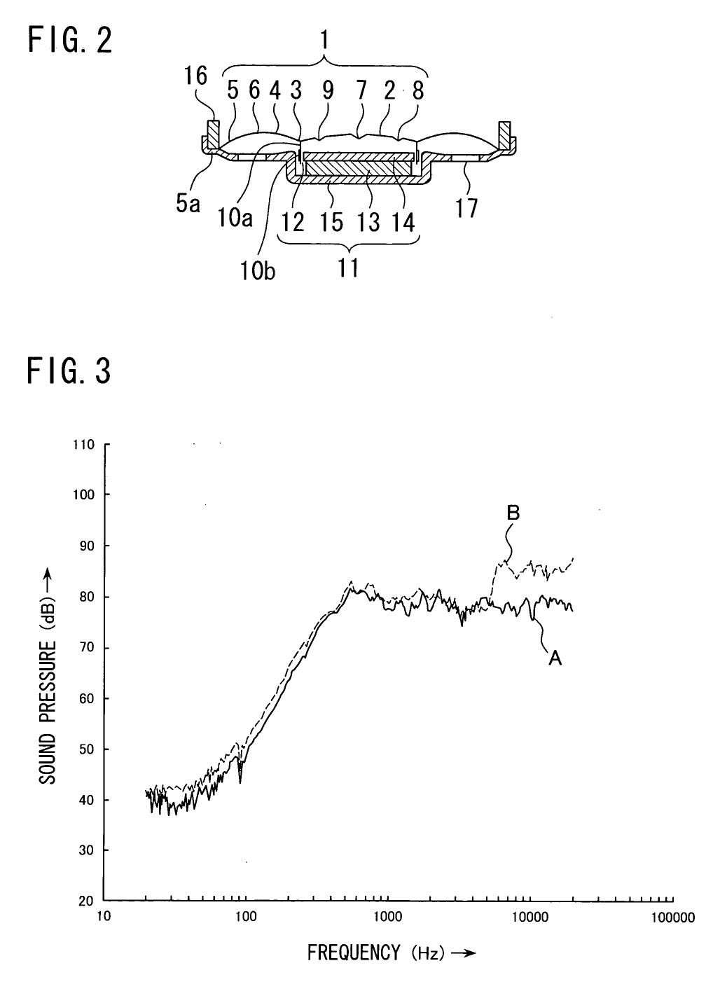

In FIGS. 1 and 2, a diaphragm 1 for use in speakers in the first embodiment according to the present invention is made as a whole of a circular resin molding, which comprises a center dome 2 forming in the center a dome shape of a large radius of curvature, an annular diaphragm part 4 formed integrally and concentrically with the center dome 2 through an annular voice-coil joining part 3 which is constituted by an outer peripheral edge of the center dome 2, an annular edge 5 constituted by an outer peripheral part of the diaphragm part 4, and a frame joining part 5a provided at outer peripheral end of the edge 5. The diaphragm part 4 swells in the same direction as the center dome 2 and forms an annular ridge 6 shown by a double-dot chain line between the part 4 and the outer peripheral edge 5. The voice-coil joining part 3 is formed, therefore, by means of a valley part between the center dome 2 and the diaphragm part 4 both swelling, or by means of a narrow flat region provided at the valley part.

As shown in FIGS. 1A and 1B by the double-dot chain line, integrally continuing part of the diaphragm part 4 and the edge 5 is swelling arcuate in forward direction of the entirety of the diaphragm 1.

In this embodiment, the center dome 2 made circular in the plan view of FIG. 1A and swelling forward in the sectioned view of FIG. 2 is provided with a plurality of ribs lying substantially in parallel across the interior of outer peripheral circle 2a of the dome and sinking rearward so as to be substantially V-shaped in section. In the case of this embodiment, three linear ribs 7-9 are disposed, as seen in the plan view of FIG. 1A, mutually as equally spaced, in parallel and in axial symmetry about the center O of the center dome 2.

The first rib 7 positioned in the center extends to be the longest along the diameter of the center dome 2, and is provided to have both ends at diametrically opposing points “a” and “b” on the outer peripheral circle 2a passing through the center O of the dome, that is, meeting points “a” and “b” of the diameter with the circle 2a. The second and third ribs 8 and 9 are provided respectively at equally spaced positions on both sides of the first rib 7, mutually in parallel, that is, in axial symmetry and non-radial with respect to the center O of the center dome 2.

These second and third ribs 8 and 9 are also terminated at both ends on the outer peripheral circle 2a of the center dome 2, and are provided as shown in FIG. 1A to extend respectively from one end point “c” or “e” to the other end point “d”or “f” on the outer peripheral circle 2a, to be linearly with mutually equal length but shorter than the first rib 7.

As seen in FIG. 1A, the bottom of the V-shaped sections of the first to third ribs 7-9 connects linearly between respective points a-b, c-d and e-f, whereas lines where both sides of the V-shaped section meet the spherical plane of the swelling center dome 2 draw arcs mutually converging or tapering toward respective points at both ends of the ribs. This tapering shape of the ribs makes it possible to enlarge the vibration amplitude of the entire diaphragm 1, so that the durability with respect to the input is improved to ensure a high sound pressure. With the provision of the ribs in such configuration, further, the speaker employing the high sound pressure diaphragm is made thinner remarkably, while the shape of metal mold for manufacturing the diaphragm is still kept simpler and the easiness of the molding work is ensured.

FIG. 2 shows in a sectioned view a speaker in which the foregoing diaphragm 1 for use in speakers is incorporated.

In FIG. 2, a cylindrical voice coil bobbin 10a of a shortened axial length and having a voice coil 10b wound on outer periphery at one axial end is joined with an adhesive agent to rear side of the voice coil joining part 3 provided between the center dome 2 and the diaphragm part 4, and the voice coil 10b on one end side is disposed within a magnetic gap 12 formed in a magnetic circuit 11.

The magnetic circuit 11 is constructed to be thin, including a part which functioning as a frame. That is, the magnetic circuit 11 comprises a disk-shaped magnet 13, a pole piece 14 of a disk shape slightly larger in the diameter than the magnet 13 and placed on the magnet, and a yoke 15 having in the center a recessed part housing therein the magnet 13 and pole piece 14 and a frame part expanding from outer face of rising peripheral wall of the recessed part. The magnetic gap 12 is formed between outer peripheral face of the pole piece 14 and opposing inner peripheral face of the peripheral wall of the recessed part, and the voice coil 10b is positioned in this magnetic gap 12.

On an outer periphery of the frame part of the yoke 15, the edge 5 of the diaphragm 1 is placed and is retained in position by means of a ring-shaped gasket 16.

Next, the operation of this speaker is disclosed.

When a voice current is input to the voice coil 10b of the diaphragm 1 in the above arrangement, the voice coil 10b is caused to vibrate within the magnetic gap 12, this vibration is transmitted from the voice coil bobbin 10a through the voice-coil joining part 3 to the center dome 2 and the diaphragm part 4 of the diaphragm 1, and the entire diaphragm 1 vibrates to radiate a sound responsive to the voice current.

Since, in this case, the first to third ribs 7-9 are provided in the center dome 2 of the diaphragm 1, the center dome 2 is increased in the rigidity at some portion, in the elasticity at some other portion, and in both rigidity and elasticity at still other portion, so that the respective portions will produce a resonance state of respective different vibrations while maintaining well balanced state. Therefore, with the provision of the first to third ribs 7-9, any divisional resonance can be prevented from concentrating to a single point within the center dome 2 but rather can be dispersed, whereby the sound pressure in the frequency characteristics at higher sound region can be decreased, it is possible to realize well balanced flat frequency characteristics, and the tone quality can be made excellent.

Further, since the first to third ribs 7-9 are provided to be of the length leaching at both longitudinal ends the outer periphery 2a of the center dome 2, it is ensured that the divisional resonance within the center dome 2 can be dispersed. That is, while in the case where the respective ends of the ribs do not reach the outer periphery 2a of the center dome the divisional resonance is caused to occur in the same axial symmetry mode as in the conventional diaphragm having no rib at portions between the respective ends of the ribs and the outer periphery 2a of the dome, the ribs according to the present invention are provided as extended to reach the outer periphery 2a, so that the divisional resonance can be surely dispersed.

FIG. 3 shows a comparison of the frequency characteristics of a small and thin speaker having diameter of 28 mm and thickness of 5 mm with the diaphragm 1 according to the present invention incorporated and of a similar speaker with the conventional diaphragm having no rib as shown in FIG. 11. A solid line A represents the characteristic curve of the speaker with the diaphragm of the present invention, and broken line B represents the characteristic curve of the conventional speaker. While in the broken line B an abrupt rise in the sound pressure can be seen in the higher sound range due to abnormal resonance, the sound pressure rise cannot be seen even in the high sound range in the solid line A of the present invention, and the frequency characteristics which is well balanced and flat as a whole can be obtained.

### Embodiment 2

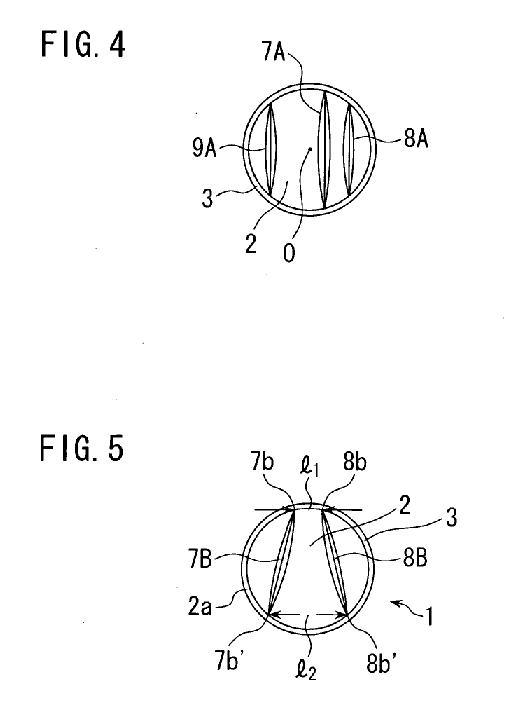

FIG. 4 shows a second embodiment according to the present invention, in which the rib comprises also the first to third ribs 7A-9A, whereas the central first rib 7A is positioned as deviated from the center O of the center dome 2, and consequently the first rib 7A is disposed to be unequally spaced from each of the second and third ribs 8A and 9A.

In FIG. 4, the space of the first rib 7A from the second rib 8A on the right-hand side is shown to be smaller, but in contrast the space from the third rib 9A may of course be made smaller.

In either event, the first to third ribs 7A-9A are disposed to so extend as to reach at both ends the outer periphery 2a of the center dome 2 and to be mutually in parallel.

### Embodiment 3

FIG. 5 shows a third embodiment of the present invention, in which a pair of ribs 7B and 8B linearly extending between respectively two points 7b and 7b′ as well as 8b and 8b′ on the outer periphery 2a of the center dome 2, to be in non-parallel, mutually diagonally and non-axial symmetry relationship. Therefore, a space l₁ between one end points 7b and 8b of the ribs 7B and 8B and a space l₂ between the other end points 7b′ and 8b′ of the ribs 7B and 8B are in the relationship l₁<l₂.

In other words, the pair of ribs 7B and 8B are disposed symmetrical, when the diaphragm 1 is viewed from front side, forming both left and right sides of an isosceles trapezoid or triangle.

### Embodiment 4

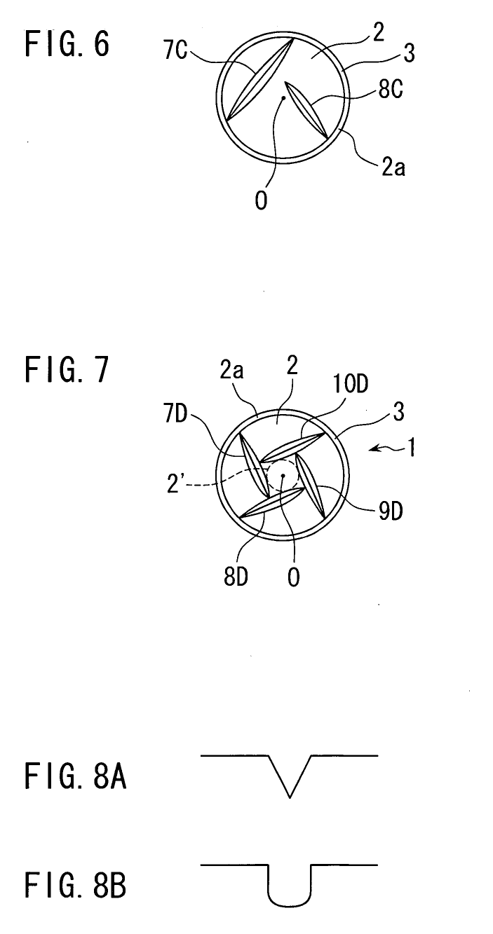

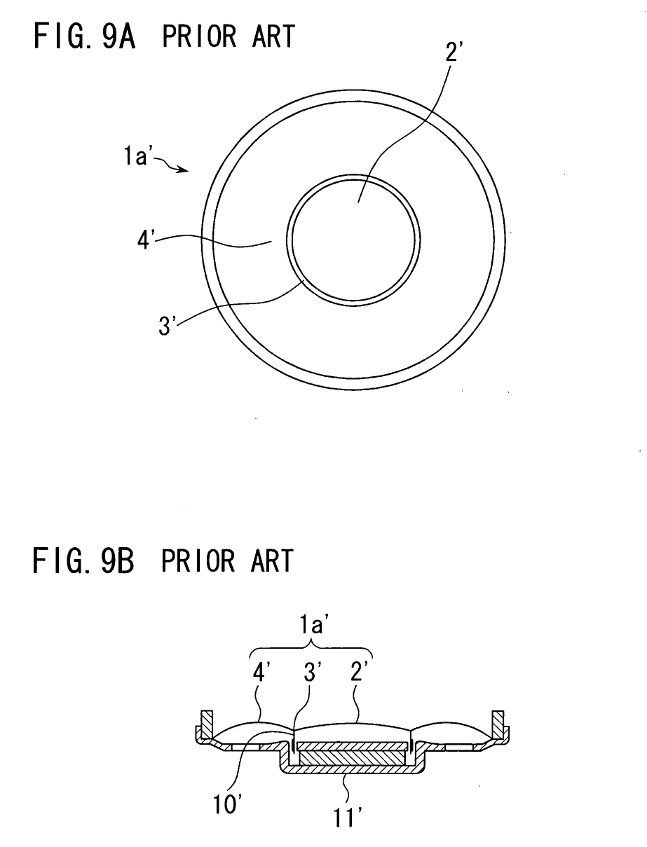

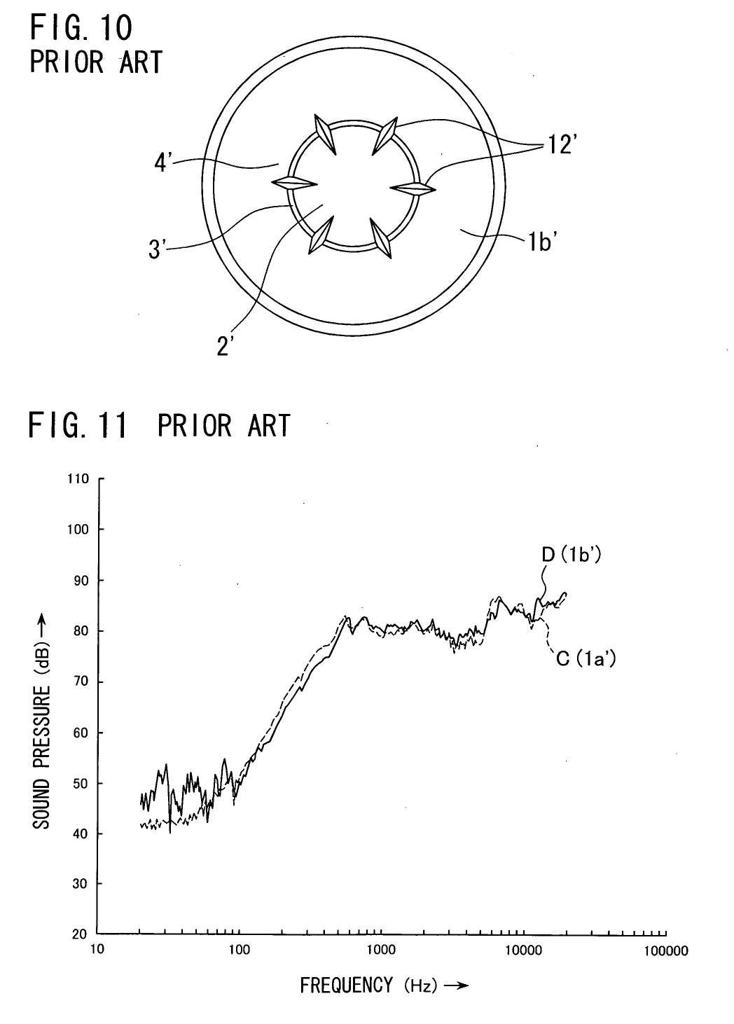

FIG. 6 shows a fourth embodiment of the present invention, which differs from the third embodiment in that a pair of ribs 7C and 8C are mutually spaced to be unparallel and different in the length.

In concrete, a longer first rib 7C extends to contact at both ends with two points on the outer periphery 2a of the center dome 2, whereas a shorter second rib 8C is positioned at one end to be closer to the center O of the center dome 2 but kept away from the first rib 7C and at the other end to be on the outer periphery 2a at a point remote from the first rib 7C. Therefore, these first and second ribs 7C and 8C are disposed mutually unparallel.

### Embodiment 5

FIG. 7 shows a fifth embodiment of the present invention, in which first to fourth ribs 7D-10D are positioned respectively with one end on the outer periphery 2a of the center dome 2 and with the other end side disposed to be tangential with respect to a circle trace of the center O of the dome while bringing the other end to be in contact with a side edge of one adjacent rib, so that respective inner side end parts of the four ribs are disposed to form a square in axially symmetrical relationship.

That is, the first to fourth ribs 7D-10D are respectively disposed to have their one end positioned at substantially equally spaced points on the outer periphery 2a of the center dome 2 and the other end positioned at substantially center point of the side edge of an adjacent rib.

As has been described in the above, a plurality of ribs are disposed, in the first and fifth embodiments, to be in axial symmetry inside the center dome but, in the second to fourth embodiments, to be in non-axial symmetry, in either event of which the respective ribs are disposed to extend in directions not radial with respect to the center O of the center dome 2, so that substantially the same action and effect can be attained throughout all embodiments. That is, the center dome of the diaphragm is provided with the plurality of ribs arranged for attaining the vibration mode in the non-axial symmetry, so that the divisional resonance occurring in axially symmetric vibration mode can be dispersed without being caused to concentrate and can be effectively reduced.

While in the respective embodiments foregoing the ribs are shown to be substantially V-shaped in section as shown in FIG. 8A, it is also possible to obtain the same action and effect even with such sectional shape of U-shape as shown in FIG. 8B.

Further, the diaphragm according to the present invention as well as the speaker using the particular diaphragm can be variously modified in design without deviating from the spirit of the present invention. In practice, the diameter, thickness, voice coil diameter and so on of the speaker are variable in many ways in response to the usage of the speaker, so that the ribs will be disposed in optimum manner in response to the usage and the performance to be shown will be optimized.

What is claimed is:

1. A diaphragm for use in speakers characterized in that, in the diaphragm which comprises a center dome of a circular dome shape and an annular diaphragm part formed continuously around the center dome through a voice-coil joining part, the center dome is provided with a plurality of ribs formed to have one of V-shape and U-shape in section and disposed to continue to outer peripheral edge of the dome at least at one of longitudinal ends of the ribs and to be in one of axial symmetry and non-axial symmetry.

2. The diaphragm according to claim 1, characterized in that the plurality of ribs in the center dome are disposed mutually in one of equally spaced patterns and unequally spaced patterns and substantially in parallel relationship.

3. The diaphragm according to claim 1, characterized in that the plurality of ribs disposed in equally or unequally spaced and mutually parallel pattern are in contact respectively at both ends with outer peripheral edge of the center dome.

4. The diaphragm according to claim 1, characterized in that the plurality of ribs in the center dome are a pair which are spaced in non-parallel relationship.

5. The diaphragm according to claim 1, characterized in that a pair of ribs mutually not in parallel in the center dome are in contact respectively at both ends with the outer peripheral edge of the center dome.

6. The diaphragm according to claim 1, characterized in that the plurality of ribs are disposed to form a square shape while surrounding the center of the center dome.

7. The diaphragm according to claim 6, characterized in that the plurality of ribs disposed in the square shape are disposed respectively in contact at one end with the outer peripheral edge of the center dome and at the other end with an adjacent one of the ribs.

8. A speaker which comprises a magnetic circuit consisting mainly of a disk-shaped magnet, a disk-shaped pole piece positioned on one surface of the magnet, and a yoke including an opposing part with respect to a circular outer peripheral edge of the pole piece while covering the other surface and side surface of the magnet for forming a magnetic gap at the opposing part and a frame part expanding from the opposing part substantially in the same plane as the pole piece and having a circular outer peripheral end, and a diaphragm consisting of a center dome of a circular dome shape and opposing the pole piece of the magnetic circuit, an annular diaphragm part formed as continuously joined at inner peripheral edge and through a voice-coil joining part with outer peripheral edge of the center dome, the diaphragm part being fixed at outer peripheral edge to outer peripheral end of the frame part of the yoke, and a bobbin joined at one axial end to the voice-coil joining part and carrying on outer periphery at the other axial end a voice coil retained within the magnetic gap, characterized in that the center dome of the diaphragm is provided with a plurality of ribs formed to be of one of V-shape and U-shape in section and to be in contact at least at one longitudinal end with the outer peripheral edge of the center dome, the ribs being disposed in one of axial symmetry and non-axial symmetry.
